(19) United States
(12) Patent Application Publication
(10) Pub. No.: US 2021/0282333 A1
(43) Pub. Date: Sep. 16, 2021

(54) REMOVABLE BASE PLANTER SYSTEM

(71) Applicant: John M Cooper, Elma, WA (US)

(72) Inventor: John M Cooper, Elma, WA (US)

(21) Appl. No.: 16/818,030

(22) Filed: Mar. 13, 2020

(51) Int. Cl. A01G 9/02

(52) U.S. Cl. CPC A01G 9/02; A01G 2009/003

(57) ABSTRACT

A removable-base planter system that permits nesting of pots as a planting grows larger than may be supported by a single planting pot is disclosed. The removable-base planter system has one or more nesting planter pots. A first planter pots having a set of bottom drain holes and a set of side drain holes permitting roots of a planting to grow out of the bottom of a planter pot and into soil of a second planter pot. A removable base is coupled to the second planter pot covering the set of bottom drain holes and the set of side drain holes. The one or more nesting planter pots may be nested in any number of planter pots in which the first planter pot above the second planter pot has been buried into soil of the second planter pot to a distance deep enough to completely cover the set of bottom drain holes and the set of side drain holes and the diameter of a bottom of the first planter pot is smaller than the diameter of a top edge of the second planter pot.

### TECHNICAL FIELD

This application relates in general to an article of manufacture for providing a nesting set of planter pots, and more specifically, an article of manufacture for providing a removable-base planter system that permits nesting of pots as a planting grows larger than may be supported by a single planting pot.

### BACKGROUND

Plantings are typically grown from a seed or small cutting from an existing plant that requires little dirt and water as the planting begins to grow. Over time, the planting grows larger above the dirt while a root system for the planting grows into the dirt in order to obtain more water and nutrients. If a planting is started in a small planting pot, the root system is likely to outgrow the available space and require replanting of the entire plant and its associated dirt into a larger planting pot with additional dirt. This larger planting pot and additional dirt permit the root system to continue to grow, and thus support, a larger planting.

The replanting of a root system and plant typically requires the root system to be disturbed and reestablished in a larger planting pot. The disturbing of the root system may cause harm to the planting or slow the continuing growth of the planting when the root system is not fully established in a larger planting pot. A planting would grow more readily and with less risk to the planting if the expansion of the available dirt for supporting the root system did not require that the existing root system be disturbed to accomplish this expansion. Existing planting pot systems typically do not support such an expansion.

The present invention attempts to address the existing limitations in supporting a set of removable-base nesting planting pots according to the principles and example embodiments disclosed herein. With the use of a set of nesting planting pots, the available space in which a root system may grow may be expanded without a need to disturb an existing root system, and thus support an ability to grow plantings to a naturally-occurring maximum size.

### SUMMARY

In accordance with the present invention, the above and other problems are solved by providing an article of manufacture for providing a removable-base planter system permitting nesting of pots as a planting grows larger than may be supported by a single planting pot.

In one embodiment, the present invention is an article of manufacture for providing a removable-base planter system that permits nesting of pots as a planting grows larger than may be supported by a single planting pot. The planter system has one or more nesting planter pots, and a removable base coupled to the second planter pot covering the set of bottom drain holes and the set of side drain holes. a first planter pots includes a set of bottom drain holes and a set of side drain holes permitting roots of a planting to grow out of the bottom of a planter pot and into soil of a second planter pot. The one or more nesting planter pots may be nested in any number of planter pots in which the first planter pot above the second planter pot has been buried into soil of the second planter pot to a distance deep enough to completely cover the set of bottom drain holes and the set of side drain holes. The diameter of a bottom of the first planter pot is smaller than the diameter of a top edge of the second planter pot.

In another embodiment, the present invention is a method for growing a planting using a removable-base planter system. The method starts a planting in a first planter pot having a removable base, waters the planting as the roots grow through a set of drain holes of the first planter pot, when the roots have begun to grow out of the drain holes of the first planter pot, removes the removable base from the first planter pot and burying the first planter pot into soil within a second planter pot, attaches the removable base to the second planter pot and continuing to water the planting, and harvests the planting after an end of a growing season. The first planter pot above the second planter pot has been buried into soil of the second planter pot to a distance deep enough to completely cover the set of bottom drain holes and the set of side drain holes, and the diameter of a bottom of the first planter pot is smaller than the diameter of a top edge of the second planter pot.

The great utility of the invention is that the article of manufacture may provide a removable-base planter system that permits nesting of multiple planting pots as a planting grows larger than may be supported by a single planting pot.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate a side view and a top view for one potential embodiment of an article of manufacture for providing a removable-base planter system that permits nesting of pots as a planting grows larger than may be supported by a single planting pot according to the present invention.

FIGS. 2a-b illustrate a side view and a top view for an example embodiment of a set of planting pots that provide a removable-base planter system that permits nesting of pots as a planting grows larger than may be supported by a single planting pot according to the present invention.

FIG. 3 illustrates a flowchart for a process of growing a planting using a removable-base planter system that permits nesting of pots as a planting grows larger than may be supported by a single planting pot.

### DETAILED DESCRIPTION

This application relates in general to an article of manufacture for providing a removable-base planter system that permits nesting of pots as a planting grows larger than may be supported by a single planting pot.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc.

As used herein, the term “about” means that dimensions, sizes, formulations, parameters, shapes, and other quantities and characteristics are not, and need not, be exact, but may be approximated and/or larger or smaller, as desired, reflecting tolerances, conversion factors, rounding off, measurement error, and the like and other factors known to those of skill. Further, unless otherwise stated, the term “about” shall expressly include “exactly,” consistent with the discussion above regarding ranges and numerical data.

The term “planter pot” refers to an enclosed vessel for holding dirt for growing a planting from a seed or cutting that is part of a removable-base planter system that permits nesting of pots as a planting grows larger than may be supported by a single planting pot.

The term “user” and “grower” refers to an entity, e.g. a human, that uses one or more planter pots according to the present invention in order to bring about a desired effect or outcome, particularly to provide the user an ability to support an instrument. In a particular case, the user is one who grows a planting using a removable-base planter system that permits nesting of pots as a planting grows larger than may be supported by a single planting pot. For such a user, the terms “user” and “grower” may be used herein interchangeably.

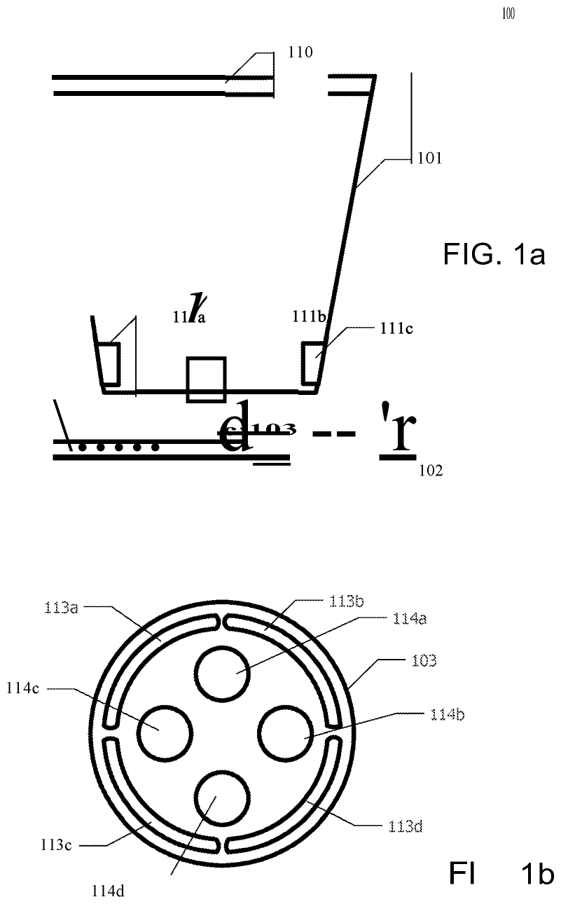

In general, the present disclosure relates to a removable-base planter system that permits nesting of pots as a planting grows larger than may be supported by a single planting pot. To better understand the present invention, FIGS. 1a-b illustrate a side view and a top view for one potential embodiment of an article of manufacture for providing a removable-base planter system that permits nesting of pots as a planting grows larger than may be supported by a single planting pot according to the present invention. FIG. 1a illustrates a side view of a removable-base planter system. The planter pot 101 includes a removable base 102 that readily attaches to the bottom of the planter pot 101. The removable base 102 is sized to completely cover the entire bottom of the planter pot 101 as well as a set of sidewall drain holes 111a-n around the bottom of the planter pot 101. In a preferred embodiment, the removable base 102 has a plurality of drain holes 103 to assist in preventing an excess buildup of water within the lowest planter pot. When the removable base 102 is attached to the planter pot 101 in alternate embodiments, drain hole 103 is not present and the sides of the removable base 102 prevent water from escaping from within the planter pot 101 while the base 102 is attached. The planter pot 101 may also include a top lip around the outer edge of the top of the pot itself.

FIG. 1b illustrates a top view 103 of the planter pot 101 looking down toward the inside surfaces of the pot. The bottom surface 103 of the planter pot 101 includes a set of bottom drain holes 113a-d and 114a-d through the bottom of the planter pot. These bottom drain holes 113a-d and 114a-d function similarly to the sidewall drain holes 111a-n as the removable base 102 will prevent water from escaping the planter pot 101 when attached. The bottom drain holes 113a-d and 114a-d shown in FIG. 1b are for illustrative purposes. Many different patterns of holes may be used for the present invention. As such, the present invention should not be limited to any particular pattern of drain holes except as recited within the attached claims.

A planting or seed may be started in the single planter pot 101 with the removable base 102 attached. Over time, the planting typically grows, and its corresponding root system fills most or all of the available space in the single planter pot 101. At that time, the root system may begin to grow through the sidewall drain holes 111a-n and the bottom drain holes 113a-d and 114a-d, only to be deterred by the removable base 102.

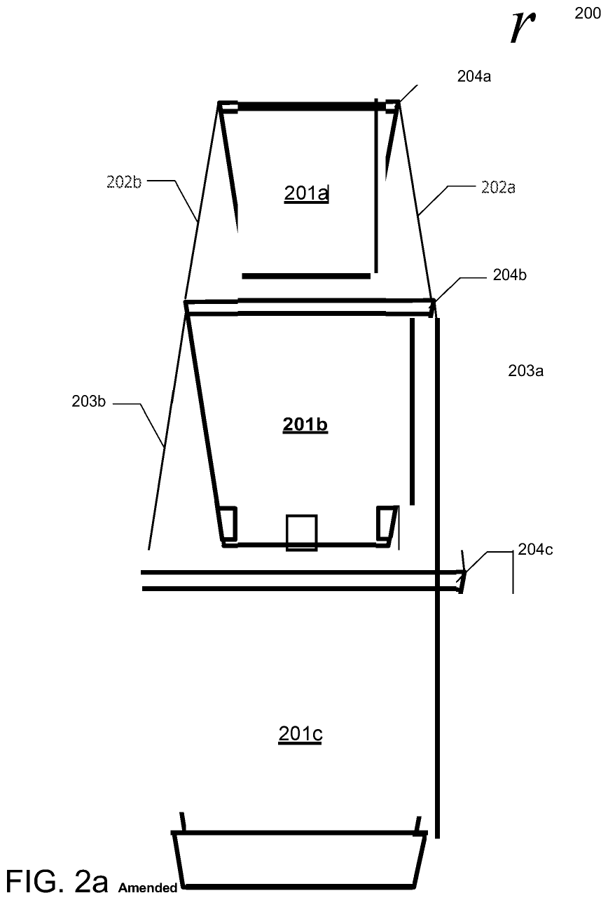

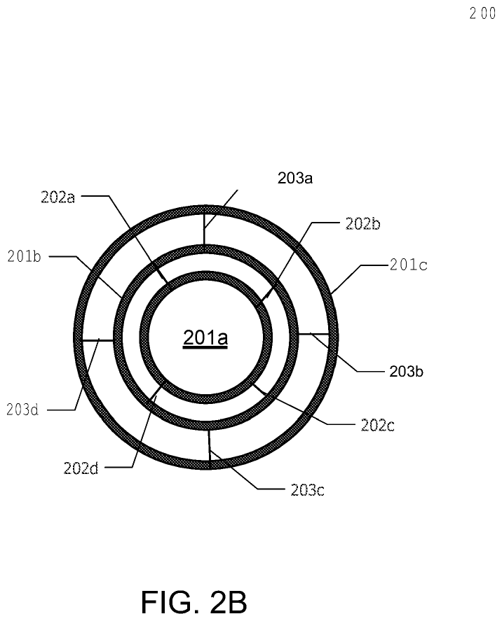

When a grower detects the root system attempting to grow through the drain holes, the first planter pot 101 may be planted in a nested fashion to provide the root system with an ability to continue to grow. The grower removes the removable bottom 102 and places the bottom of the first planter pot 101 into dirt within a second planter pot as shown in FIG. 2. The first planter pot is placed deep enough into the dirt such that all of the sidewall drain holes 111a-n as well as the bottom drain holes 113a-d and 114a-d are completely covered. As such, the root system that is growing through the drain holes may be in contact with the dirt of the second planter pot and may continue growing into the newly added dirt and space.

FIGS. 2a-b illustrate a side view and a top view for an example embodiment of a set of planting pots providing a removable-base planter system that permits nesting of pots as a planting grows larger than may be supported by a single planting pot according to the present invention. FIG. 2a illustrates a side view of three planting pots 201a-c in a nesting configuration in which the bottom planting pot 201c is attached to a removable base. The other two planter pots 201a-b are placed within the dirt of a planter pot directly below each planter pot in order to cover all of the planter pots' drain holes. The planting is started in the top planter pot 201a and the additional planter pots may be added over time as needed. Each pair of planter pots may be secured to each other using a set of guidelines in some embodiments as needed.

A first set of guidelines 202a-b couple the top planting pot 201a to the middle planting pot 201b. A second set of guidelines 203a-b couple the middle planter pot 201b to the bottom planter pot 201c that has a removable base 202 attached thereto. The present invention has typically been found to be stable when a planting pot is located sufficiently deep into the dirt of a lower planter pot. As such, in a preferred embodiment, sets of guidelines may not be needed to keep nested planting pots stable while in use. Sets of guidelines 202a-b and 203a-b may be useful in some environments as needed.

The set of guidelines 202a-b and 203a-b may consist of any number of separate lines in which one end of the line is coupled to the top lip 204a-b of a first planter pot 210a-b above a second planter pot 201b-c to the top lip 204b-c of the second planter pot 201b-c below the first planter pot 201a-b. Each level of the nesting pots may possess its own set of guidelines in various numbers. In one embodiment, a clip device may be attached to each end of the guidelines in which the clip device may couple around the top lip of the planter pots. This form of attachment to the planter pots may also include other coupling mechanisms such as bendable wire passing through attachment holes in the top lip of the planter pots, S-shaped hooks, and attachable rings.

While FIG. 2a shows three nested planter pots 201a-c, one of ordinary skill will recognize that any number of planter pots may be nested in this fashion. Additionally, the three planter pots 201a-c are shown in FIG. 2a to consist of a set of planter pots that increase in overall size as the nesting of planter pots progress from the top planter pot 201a to the bottom planter pot 201c. This varying in size is shown for descriptive purpose and planter pots of the same size may also be used in a set of nesting planter pots. The diameter of the bottom of a particular planter pot must fit within the dirt within the diameter of the top of the next lower planter pot. If each planter plot is sized that its bottom diameter is smaller than its top diameter at the height of the dirt contained therein, each planter pot may be nested in a similar fashion to the ones of FIG. 2a.

When a top planter pot 201a is nested into the middle planter pot 201b, the grower may water the planting by adding water to the middle planter pot 201b. This process may encourage the planting's root system to continue to expand into the middle planter pot 201b in order to obtain needed water for continuing plant growth. This process may continue throughout the entire growing season for the planting. Once the growing season has concluded and any crop has been harvested, the nesting set of planter pots 201a-c may be separated, and the planting removed from therein. The set of planter pots may be reused the following growing season.

FIG. 2b illustrates a top view of the nested set of three planter pots from FIG. 2a. In this example embodiment, the three planter pots 201a-c are shown having an increasing diameter from top to bottom of the nesting set of planter pots. This fact is used to permit each of the top rims of each planter pot to be visible in FIG. 2b as well as all of the guidelines in the two sets of guidelines 202a-d and 203a-d. In an embodiment in which the planter pots are the same size, the top view may not show all of the levels of the nesting planter pots as the bottom planter pot may be hidden behind the planter pots above. Each level of the set of nesting planter pots are shown with a set of guidelines 202a-d and 203a-d. These guidelines are shown to be located at different locations for each level. The location of these guidelines may be chosen as needed to keep the set of nesting planter pots upright and secure.

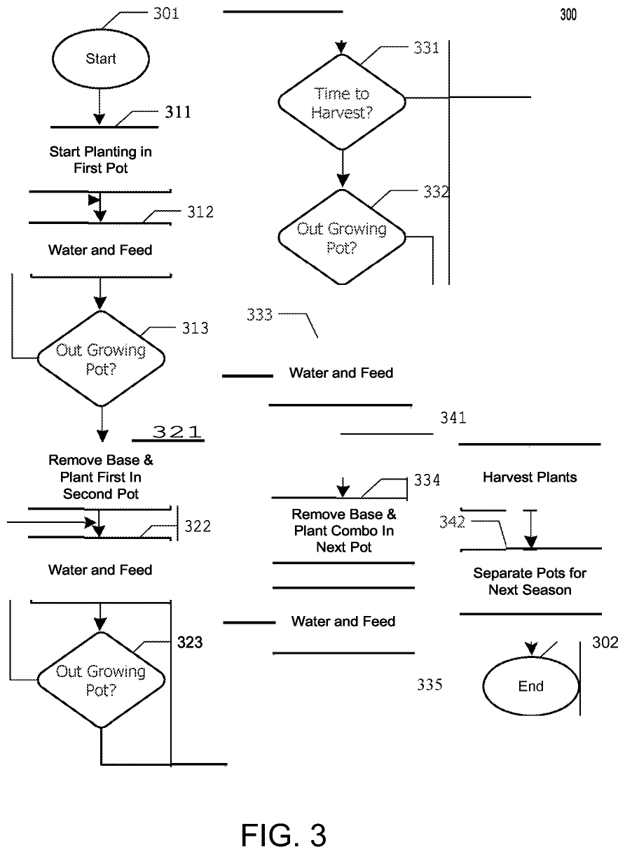

FIG. 3 illustrates a flowchart for a process of growing a planting using a removable-base planter system that permits nesting of pots as a planting grows larger than may be supported by a single planting pot. The process of using a planter system having a removable base begins 301 and the grower plants a seed or cutting within a first planter pot 201a in step 311. The grower, in step 312 waters and feeds the planting in order to assist the planting's growth. Test step 313 determines whether the root system of the planting has outgrown the first planter pot 201a, and if not, the process returns to step 312 to continue feeding and watering the planting while it continues to grow.

When test step 313 determines that the root system has outgrown the first planter pot 201a, the grower removes the base 202 from the first planter pot 201a and adds the bottom of the first planter pot to the dirt in a second planter pot 201b in step 321. The planting is watered and fed in step 322 and test step 323 determines whether the root system has outgrown the second planter pot 201b, and if not, returns to step 321 to continue the growing process as described above.

When test step 323 determines that the root system has outgrown the second planter pot 201b, test step 331 determines whether it is now time to harvest the crop as the growing season ends. If test step 331 determines it is not yet time to end the growing season, the process continues through a processing loop similar to the loops described above. Test step 332 determines whether the root system has outgrown the bottom planting pot 202b. If it has not outgrown the bottom planting pot 201b, the planting is watered and fed in step 333 before returning to test step 331. If test step 332 determines that the planting has outgrown the bottom planting pot 201b, the planting and its nesting set of planting pots 201a-b are added to another level of nesting pots 201c in step 334 and the planting is watered and fed in step 335 before once again returning to test step 331. Looping through these steps continues until the growing season ends and test step 331 determines that it is now time to harvest. Before reaching the time to harvest, the process will add as many levels of nesting planting pots as needed to support the root system of the planting as it grows. At harvest time, the grower may harvest any crop remaining on the planting in step 341. The nested set of planting pots 201a-c may be separated in step 342 by the grower with the set of planter pots being available for use in a following growing season after the process ends 302.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A removable-base planter system, the planter system comprises:
one or more nesting planter pots, a first planter pots having a set of bottom drain holes and a set of side drain holes permitting roots of a planting to grow out of the bottom of a planter pot and into soil of a second planter pot;
a removable base coupled to the second planter pot covering the set of bottom drain holes and the set of side drain holes;
wherein the one or more nesting planter pots may be nested in any number of planter pots in which the first planter pot above the second planter pot has been buried into soil of the second planter pot to a distance deep enough to completely cover the set of bottom drain holes and the set of side drain holes; and
wherein the diameter of a bottom of the first planter pot is smaller than the diameter of a top edge of the second planter pot.

2. The planter system according to claim 1, wherein the planter system further comprises a set of guidelines coupled to the top edge of the second planter pot to a top edge of the first planter pot once the first planter pot has been buried into soil of the second planter pot.

3. The planter system according to claim 2, wherein the removable base possesses one or more drain holes.

4. The planter system according to claim 1, wherein the planter system is used during a single growing season and disassembled once the planning has been harvested.

5. The planter system according to claim 1, wherein the first planter pot is smaller in size than the second planter pot.

6. The planter system according to claim 1, wherein the first planter pot and the second planter pot are identical in size.

7. The planter system according to claim 1, wherein the set of nesting planter pots is three or more planter pots deep.

8. A method for growing a planting using a removable-base planter system, the method comprising:
starting a planting in a first planter pot having a removable base;
watering the planting as the roots grow through a set of drain holes of the first planter pot;
when the roots have begun to grow out of the drain holes of the first planter pot, removing the removable base from the first planter pot and burying the first planter pot into soil within a second planter pot;
attaching the removable base to the second planter pot and continuing to water the planting; and
harvesting the planting after an end of a growing season;
wherein the first planter pot above the second planter pot has been buried into soil of the second planter pot to a distance deep enough to completely cover the set of bottom drain holes and the set of side drain holes; and
wherein the diameter of a bottom of the first planter pot is smaller than the diameter of a top edge of the second planter pot.

9. The method according to claim 8, wherein the method further comprising:
when the roots have begun to grow out of the drain holes of the second planter pot, removing the removable base from the second planter pot and burying the second planter pot into soil within a third planter pot while the first planter pot remains buried in the soil of the second planter pot; and
attaching the removable base to the third planter pot and continuing to water the planting.

10. The method according to claim 9, wherein the method further comprising:
attaching a set of guidelines coupled to the top edge of the second planter pot to a top edge of the first planter pot once the first planter pot has been buried into soil of the second planter pot.
